(19) United States
(12) Patent Application Publication
(10) Pub. No.: US 2015/0314216 A1
(43) Pub. Date: Nov. 5, 2015

(54) Vortex Water Distillation Apparatus

(71) Applicants: Artem A. Khalatov, Kiev (UA); Peter Brodetsky, Encino, CA (US)

(72) Inventors: Artem A. Khalatov, Kiev (UA); Peter Brodetsky, Encino, CA (US)

(21) Appl. No.: 14/265,557

(22) Filed: Apr. 30, 2014

(51) Int. Cl. B01D 5/00; C02F 1/04

(52) U.S. Cl. CPC B01D 5/0021; B01D 5/009; C02F 1/043; C02F 2103/08

(57) ABSTRACT

A device for vortex desalting of a liquid flow is proposed, including—a condensation channel,—dividing adiabatic walls,—a channel for removal of saturated air communicating with the condensation channel,—a cooling channel having a bottom, a top entrance receiving a heated air stream cooled down in the cooling channel, and walls snug-fitted with the adiabatic walls,—a pipe mounted between the mentioned channels having at least a plurality of projected hemispherical heat exchange intensifiers, a wavy surface, an air swirler inside the pipe, tangential openings in the pipe's upper portion, a removing dehydrated air channel, coupled with the condensation channel, and a fresh water removing channel. The pipe has a lid with an opening operatively receiving the liquid flow, supplied into the pipe for desalting. The proposed device is usable for receiving fresh water from sea, ocean and “hard” water, and for extraction of fresh water from industrial drains.

### FIELD OF THE INVENTION

This present invention is related to water processing, in particular to methods and equipment for cleaning industrial drains or desalination of the sea, ocean or “salted” water.

### BACKGROUND OF THE INVENTION

Water plays a leading role in supporting human life, industrial production and agriculture. Every human being needs at least 2 liters of quality water to support his life, and about 200-500 liters with full cycle of activity.

Chemical and drying processes, ferrous and nonferrous metallurgy, energy and animal husbandry consume a lot of water. In spite the fact that there are great reserves of fresh water in the world, they are being distributed very unevenly. According to the World Health Organization, nowadays there are more than 800 million people that practically don't have access to fresh water, and more than 500 million that suffer from bad quality of water. Algeria, Libya and Kuwait import basically all fresh water they have. Technologically developed countries such as Singapore and Malaysia get their fresh water from China. Thus, deficiency of fresh water has become a very serious problem of the world.

It is known that 97.5% of world's water reserves on the Earth is a share of salty waters of the seas and oceans. That is why sea water is widely used for receiving fresh water. Average salinity of waters of the World Ocean is about 35 g/kg of sea water. Now there are a few methods that are used for desalting sea water but all of them are energy consuming. The search of less expensive methods ways to produce fresh water from the seas is one of the most important tasks of the XXI century.

It's extremely important to create new technologies for processing fresh water from industrial drains. They will allow to decrease industrial water consumption, to reduce waste water discharge into surrounding space and to minimize harmful impact of the industry on environment. Debilitation of a so-called “hard” water extracted from deep layers of the Earth and from reservoirs is very promising and important. A required degree of purity of fresh water for use by people is 99%, or 1 gram of salts in 1 liter of water.

The most efficient way of the fresh water extraction is the reverse osmosis technology that requires about 3 kWt-hours of electric power to produce one cubic meter of a fresh water. However, the most common and, at the same time, the most energy consuming method of receiving fresh water is the distillation process that evaporates fresh water from sea water or industrial drains and condensates it. The method requires up to 20 kw-hours of electric power for producing 1 cubic meter of fresh water. Besides, this method has a number of serious disadvantages. The main one is corrosion of the surface of heating and sedimentation of insoluble salts on the surface. The world's largest installation of this system is located in Saudi Arabia, where daily consumption of fresh water is about 500 liters per 1 person. In this aspect, French Patent No. 1,162,054, U.S. Pat. No. 4,197,713 and U.S. Pat. No. 4,219,341 stand out among known patents.

Other technologies (vacuum distillation, ionic exchange, chemical sedimentation, solar de-salters, and mechanical methods) are characterized by expenses from 3 to 20 kWt-hours of electric power. In particular, the vacuum distillation is described in UK Patent No. 549,519 and U.S. Pat. Nos. 6,423,187 and 6,689,251, 4,576,014, and some others.

There known several inventions (USSR Inventor's Certificate No. 623062; U.S. Pat. No. 4,350,570, U.S. Pat. No. 6,854,278, and U.S. Pat. No. 8,613,839) that discussed the use of an indirect evaporative cooling technology for receiving a fresh water from sea water. As shown in the analysis, the cost of one ton of fresh water production may be the same when using the reverse osmosis technology. The main disadvantage of this type of desalter is the necessity of using a semipermeable surface in the channel of evaporation that has a tendency of fast contamination and causes a malfunction. When operating, it is difficult to adjust the mass flow rate of the liquid supplied and liquid evaporated from a semipermeable surface. Besides, the equipment discussed in these patents is characterized by a low productivity and large dimensions of desalters caused by a low speed of air in evaporation channels (about 1-2 m/s), which is necessary for prevention of drop ablation of the evaporating liquid from the surface of a flowing-down film.

In recent years, methods of indirect evaporative cooling have been considered for desalting and found to have great prospects. These methods are characterized with high energy efficiency as they use energy of surrounding space in the form of a psychometric difference of air temperatures. Its main advantage is a possibility to combine evaporation and condensation processes in one device. Today such methods are widely used for producing cold in compressor-less central air systems.

Thus, the direction of improving methods of indirect evaporative cooling and designing new equipment based thereon is very important today.

### SUMMARY OF THE INVENTION

The subject of this invention is a new vortex device that allows receiving fresh water from sea, ocean and “rigid” water and reproducing fresh water from industrial drains. This device combines the principle of indirect vaporizing cooling with a stream swirl in channels of evaporation and condensation for receiving fresh water.

The purpose of this invention is an intensification of a liquid evaporation and water condensation, decrease of energy expenses for production of fresh water, weight and dimensions of desalters of water, simplification of their design.

The use of indirect vaporizing cooling of liquid (U.S. Pat. No. 4,350,570, U.S. Pat. No. 6,854,278, and U.S. Pat. No. 8,613,839) allows for organizing processes of evaporation of liquid and vaporing in one device at the expense of heat transfer. At the same time, 100% humidity of air is reached at the exit from the channel of evaporation. Besides, enthalpy of a steam-air stream is 3-4 times higher than at usual moistening of air.

### BRIEF DESCRIPTION OF DRAWINGS

The invention is illustrated in the attached drawings wherein:

FIG. 1 shows a frontal vertical sectional view of apparatus, according to a preferred embodiment of the present invention.

FIG. 2 shows a plan view of apparatus, according to the preferred embodiment of the present invention depicted on FIG. 1.

FIG. 3 shows a horizontal sectional view of apparatus, according to the preferred embodiment of the present invention depicted on FIG. 1.

Elements of the inventive apparatus are designated with the following reference numerals: 1—walls of the channel 8 (see below) for stream condensation; 2—walls of a channel 17 (see below) for preliminary cooling of air; 3—adiabatic dividing walls; 4—pipe; 5—lid; 6—opening; 7—air swirler; 8—channel of stream condensation formed by the walls 1 and the wavy surface 14 (see below); 9—twirled film of liquid on the internal surface of the pipe 4; 10—a plurality of tangential openings in the pipe 4; 11—tail of the swirler 7; 12—a stream of heated air; 13—liquid for desalting; 14—wavy surface created on the external surface of pipe 4; 15—channel for branching some of saturated air from channel 8; 16—first valve; 17—channel for preliminary cooling of air formed by the surface of pipe 4; 18—heat exchange intensifiers (hemispherical ledges) mounted on the external surface of pipe 4; 19—unevaporated liquid at the bottom of channel 17; 20—channel for removing unevaporated water from channel 17; 21—channel for removing dehydrated air from channel 8; 22—fourth valve; 23—fresh water at the bottom of channel 8; 24—saturated twirled swirling air stream of air; 25—second valve; 26—third valve; 27—channel for removing fresh water from channel 8; 28—bottom of the channel 17; 29—bottom of the channel 8; 30—thermal insulation mounted on a part of the external surface of walls 2 of the channel 17; and 31—hemispherical ledges on the external surface of walls 1.

### DETAIL DESCRIPTION OF A PREFERRED EMBODIMENT OF THE INVENTION

While the invention may be susceptible to embodiment in different forms, there are described in detail herein below, specific embodiments of the present invention, with the understanding that the instant disclosure is to be considered an exemplification of the principles of the invention, and is not intended to limit the invention to that as described herein.

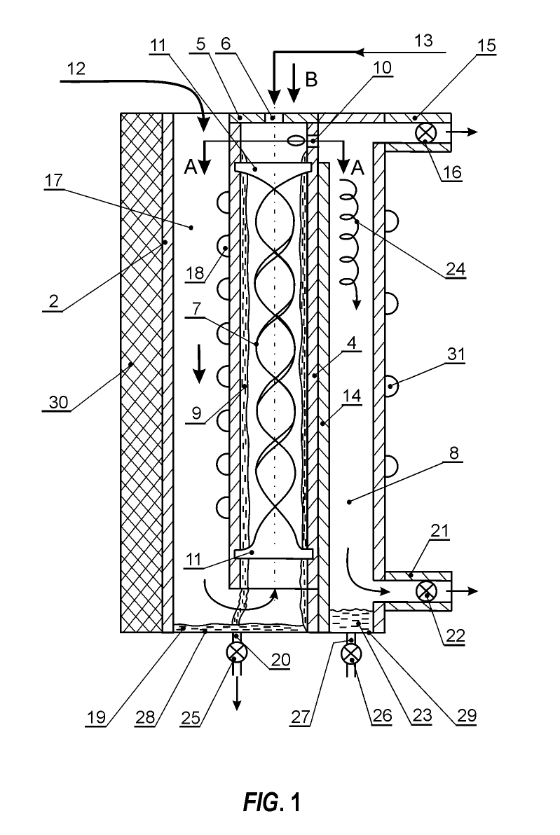

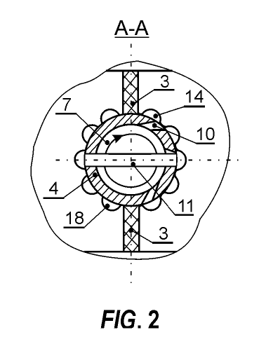

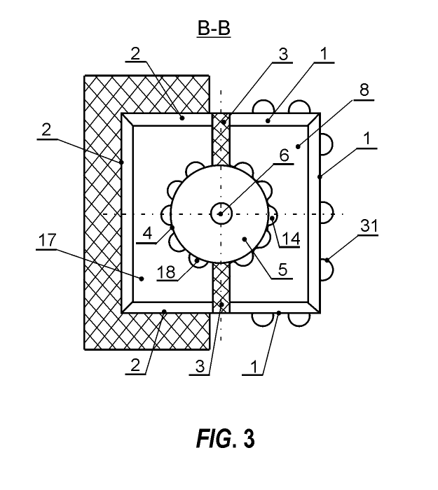

Thus, according to the present invention, the device for vortex water desalting (FIGS. 1-3) in a preferred embodiment comprises:
a channel 8 for stream condensation, mounted substantially vertically, including: a channel bottom 29 and walls 1 having an external surface;
two substantially vertical adiabatic walls 3, with a predetermined height, snug-fitted with the walls 1 along the predetermined height;
a channel 15 for removal of a portion of saturated air through a first valve 16 mounted within the channel 15, said channel 15 communicates with a top part of the channel 8 and is attached to the external surface of the wall 1;
a channel 17 for preliminary cooling the heated air stream, mounted substantially vertically, including: a bottom 28 connected with a channel 20 attached thereto and furnished with a second valve 25, a top entrance operatively receiving a heated air stream 12 intensively cooled down in the channel 17, and walls 2 snug-fitted with the adiabatic walls 3 along the predetermined height; wherein the walls 2 are externally covered with thermal insulation 30, the bottom 28 collects unevaporated liquid 19 periodically removed through the channel 20 and the valve 25;
a pipe 4, substantially vertically mounted between the channel 8 and the channel 17; the pipe 4 includes:
   an internal surface whereon a swirling liquid film 9 is operatively formed;
   a first external surface contacting the channel 17;
   a plurality of heat exchange intensifiers 18 in the form of hemispherical ledges, mounted on the first external surface;
   a second external surface contacting the channel 8;
   a wavy surface 14 mounted on the second external surface;
   a lid 5 closing the pipe 4 from above and having an opening 6 operatively receiving a water flow 13, supplied through the opening 6 into the pipe 4 for desalting;
   an air swirler 7 mounted inside the pipe 4, having a spiral form and creating a progressive-rotary motion of an air flow therein; wherein the air swirler 7 has two tails 11 fixedly mounted in a lower part and a top part of the pipe 4 for control of a gap (5 . . . 10% of a radius of the pipe 4) between the swirler 7 and the internal surface of the pipe 4;
   a plurality of tangential openings 10 made in the top part of the pipe 4 (through which, the swirling air-steam stream with 100% of humidity operatively leaves the pipe 4);
a channel 21 for removing dehydrated air to the atmosphere, coupled with a lower part of the channel 8 and connected to the external surface of the wall 1; said channel 21 is furnished with a fourth valve 22 mounted therein; and
a channel 27 for periodic removing fresh water 23, coupled to the channel bottom 29; said channel 27 is furnished with a third valve 26 mounted therein.

### OPERATION OF THE PREFERRED EMBODIMENT OF INVENTION

To implement the principle of indirect evaporative cooling, the inventive vortex desalter (FIGS. 1-3) includes three consecutive channels:—a channel of preliminary air cooling 17,—a pipe 4 with a swirling film of liquid 9 on the internal surface of the pipe 4 (a channel of liquid evaporation), and—a condensation channel 8. The areas of cross section of all of the three channels are essentially equal for maintaining identical speed of a stream and decreasing hydraulic losses at the stream turn on the entrance and the exit from the pipe 4. The condensation channel 8 is separated from the channel 17 by two vertical adiabatic dividing walls 3 that contact with the surface of the pipe 4 along the height thereof going in two opposite directions, and with the walls 1 and 2.

For intensification of the liquid film 9, evaporation in the pipe 4, a swirler 7 is installed. The swirler of steam-air stream allows to significantly increase the stream's speed (up to 10 m/s) in comparison with devices of indirect evaporative cooling described in USSR Inventor's Certificate No. 623062; U.S. Pat. No. 4,350,570, U.S. Pat. No. 6,854,278, and U.S. Pat. No. 8,613,839, and increase the amount of evaporating liquid at the expense of a progressive-rotary motion. At the same time, at the expense of the air stream swirler and radial gradient of pressure in the pipe 4 in the wide range of speeds, a steady swirling movement of the liquid film without drop ablation from its surface remains [References 1, 2].

The high intensification of condensation in the channel 8 is provided by swirling of saturated water air stream at the exit from the channel 4 through the tangential openings 10 in the pipe 4; and also by the use of the wavy surface 14 on the external surface of the pipe 4, which surface can be covered by surface-active substances that improve drop condensation.

All three walls 2 of the channel 17 from the outer side are covered with the thermal insulation 30 for exclusion of thermal losses into surrounding space; and for additional stream cooling in the channel branch of heat flow in surrounding space through the wall 1 with the surface intensifiers, the ledges 31 of a hemispherical form are used.

After leaving the tangential openings, a portion of saturated air (20 . . . 40%) is discharged into the atmosphere through the outlet channel 15 wherein the first valve 16 serves to control a steam-air mass flow rate in the channel 8; a saturated water air stream in the channel 8 is intensively cooled down by means of the air-steam flow swirling, and transfer of the heat separated due to the water condensation on the wavy surface 14, from the channel 8 into the pipe 4 for evaporation of the swirling film 9; the film of condensed fresh water flows down on the wavy surface 14, is collected on the bottom of channel 29 and the captured fresh water 23 is removed through the channel of fresh water removal 27 that is attached to the channel bottom 29, the channel of fresh water removal 27 is supplied with a third valve 26 for periodic removal of fresh water, and dehydrated air is removed into the atmosphere through the outlet channel 21 with valve 22 that stops supplying the atmospheric air into the channel 8; additional cooling of steam-air stream in the channel 8 is provided by heat transfer into surrounding space through three walls 1 with hemispherical intensifiers of heat exchange 31 on the outer sides.

The principle of operation of the vortex evaporator is in the following. Heated air 12 (possibly after solar heater) moves to the channel 17 wherein it's cooling on the way down at the expense of heat transfer to the swirling film of liquid 9 through the surface of the pipe 4 with the heat exchange intensifiers 18. If a channel 17 is long enough (more than 50 diameters of the pipe 4) air temperature reaches temperature of a dew-point of entering air where stream moves in a pipe 4, i.e. the air stream becomes saturated (100% humidity).

Liquid 13 for desalting (sea, ocean, industrial drains, “rigid” water etc.) moves into the opening 6 in the lid 5 wherein, due to interaction with the ascending swirling stream of air, it is thrown to the internal wall of the pipe 4 and flows down under the influence of gravitation force in the form of the swirling film 9. the swirler 7 in the pipe 4 is installed with the gap from 5 to 10% of pipe's [References 1, 2] radius for free draining of the swirling film of liquid. Control of constancy of the gap along the length of the pipe 4 is provided by the swirler 7 in the pipe 4 with two tails (or “shafts”) 11.

When the swirling stream moves from below up the pipe 4; there is an intensive liquid evaporation from the surface of the swirling film 9. The heat flow, necessary for evaporation of liquid comes from the channel 17 when air cools in it, and also from the channel 8 when the saturated swirling stream of air 24 cools at condensation on the wavy surface 14. The counter-flow scheme of movement of air and the swirling film help arranging an effective evaporation of the liquid. Unevaporated (more concentrated) liquid 19 is collected on the channel bottom 28 and is periodically removed through the channel 20 and the second valve 25.

The swirling twirled steam-air stream of 100% of humidity leaves the channel 4 through the tangential openings 10 while keeping a swirler that reduces hydraulic losses when the stream moves to the top part of pipe 4. Temperature of the steam-air stream at the exit from tangential openings 10 (on the entrance to the channel 8) is equal to the saturation temperature. To provide a fuller water condensation from 20 to 40% of the steam-air stream (U.S. Pat. No. 6,854,278), the steam-air stream from the tangential channels 10 is removed into the atmosphere through the outlet channel 15 with the first valve 16.

In the channel 8, cooling of the steam-air stream happens at the expense of moisture condensation (and heat flow allocations) on the wavy surface 14 and a transfer of the heat into surrounding space through the walls 1 with the heat exchange intensifiers 31. The intensification of condensation is improved by a vortex (swirling) movement of the stream 24. The condensed (fresh) water is collected on the bottom of the channel 23, then is removed through the channel 27 from the third valve 26. The dehydrated air from the channel 8 is removed into the atmosphere through the outlet channel 21 from the fourth valve 22.

The inventive vortex device for desalting can be used for processing water and receiving fresh water from sea, ocean and “hard” water, and also for extraction of fresh water from industrial drains.

### REFERENCES

[Reference 1] A. A. Khalatov. Theory and practice of twirled streams. Kiev. Publisher Naukova Dumka.—1989—198 pages.

[Reference 2] A. A. Khalatov, I. I. Borisov, S. V. Shevtsov. The heat exchange/mass transfer and heathydraulic efficiency of the vortex and twirled streams [symbol] Kiev. Publisher: NAN Institute of technical thermal physics of Ukraine.—2005.—500 pages.

We claim:

1. A device for vortex desalting of a water flow (13) comprising:
a channel (8) for stream condensation, including: a channel bottom (29) and walls (1) having an external surface;
two adiabatic walls (3), with a predetermined height, snug-fitted with the walls (1) along the predetermined height;
a channel (15) for removal of saturated air through a first valve (16) mounted within the channel (15), said channel (15) communicates with a top part of the channel (8) and is attached to the external surface of the wall (1);
a channel (17) for preliminary air cooling, including:
a bottom (28) attached to a channel (20) furnished with a second valve (25),
a top entrance operatively receiving a heated air stream (12) cooled in the channel (17), and
walls (2) snug-fitted with the adiabatic walls (3) along the predetermined height;
a pipe (4), mounted between the channel (8) and the channel (17); said pipe 4 includes:
an internal surface whereon a swirling film of liquid (9) is operatively formed;
a first external surface contacting the channel (17);
a plurality of heat exchange intensifiers (18) in the form of hemispherical ledges, mounted on the first external surface;
a second external surface contacting the channel (8);
a wavy surface (14) formed on the second external surface;
a lid (5) closing the pipe 4 from above and having an opening (6) operatively receiving said water flow (13), supplied through the opening (6) into the pipe (4) for desalting;
an air swirler (7) mounted inside the pipe (4), having a spiral form; said air swirler (7) has two tails (11) fixedly mounted in a lower part and a top part of the pipe (4) for control of a gap between the swirler (7) and said internal surface of the pipe (4); and
a plurality of tangential openings (10) formed in the top part of the pipe (4);
a channel (21) for removing dehydrated air to the atmosphere, coupled with a lower part of the channel (8) and connected to said external surface of the wall (1); said channel (21) is furnished with a fourth valve (22) mounted therein; and
a channel (27) for periodic removing fresh water from the channel (8), coupled to the channel bottom (29); said channel (27) is furnished with a third valve (26) mounted therein.

2. The device for vortex desalting according to claim 1, wherein the walls (2) are externally covered with a thermal insulation (30).

3. The device for vortex desalting according to claim 1, wherein the walls (1) are externally covered with a plurality of hemispherical ledges (31).
